(19) United States
(12) Patent Application Publication
(10) Pub. No.: US 2013/0138851 A1
(43) Pub. Date: May 30, 2013

(54) METHOD AND APPARATUS FOR EXPANDER-BASED DATA DUPLICATION

(71) Applicants: Scott W. Dominguez, Colorado Springs, CO (US); Jason C. McGinley, Colorado Springs, CO (US); Brett J. Henning, Colorado Springs, CO (US); Edoardo Daelli, Colorado Springs, CO (US); Sagar G. Gadsing, Colorado Springs, CO (US)

(72) Inventors: Scott W. Dominguez, Colorado Springs, CO (US); Jason C. McGinley, Colorado Springs, CO (US); Brett J. Henning, Colorado Springs, CO (US); Edoardo Daelli, Colorado Springs, CO (US); Sagar G. Gadsing, Colorado Springs, CO (US)

(73) Assignee: LSI CORPORATION, Milpitas, CA (US)

(21) Appl. No.: 13/307,955

(22) Filed: Nov. 30, 2011

(51) Int. Cl. G06F 13/00

(52) U.S. Cl. 710/300

(57) ABSTRACT

A data-duplicating expander device attachable to a storage topology and a method. The data-duplicating expander device may include a direct-attached SAS expander configured for direct duplication of data from source disks to destination disks by bypassing transfer to or from a host system. The device may include dedicated expander phys and a processor. The device may be configured to receive instructions from an initiator storage-topology-connected device to configure or start a data transfer. The data-duplicating expander device may be configured to receive source data from source disks by utilizing dedicated expander phys and may be configured to transfer destination data directly and simultaneously to the destination disks by utilizing dedicated expander phys, said destination data being associated with the source data. Directly transferring destination data bypasses transfer of the source data or the destination data to or from a host system.

### FIELD OF THE INVENTION

The present invention is directed generally toward a method and apparatus for utilizing an expander for data duplication of devices direct-attached to the expander.

### BACKGROUND OF THE INVENTION

Backing up data and data duplication are critical in industries dependent on data storage and data duplication. Current methods used to duplicate data involve copying data from a source disk to a destination disk through a storage topology. Transferring data through a storage topology to a host and back through the storage topology may consume a significant portion of the available bandwidth for a host bus adapter's (HBA) storage topology. In addition, as disk capacities have increased to hold multiple terabytes of data, or even larger capacities, the time for duplicating disk data can take hours or days for a single set of disks, let alone for multiple sets.

Current topologies may include multiple expanders (e.g., dozens of expanders) and multiple disk drives (e.g., hundreds of disk drives). In such large topologies the overhead required to communicate with end devices can become significant—consuming bandwidth when acquiring the source disk data, only to return the same data back down a nearly identical path to a destination disk connected to the same expander. In the case of disk duplication, the data is never modified just moved. Since SAS is a point-to-point protocol, a data connection must be established for each data transfer. At each SAS expander level in the topology, there is an opportunity for a particular SAS expander to reject the open connection, which delays the I/O. In addition, heavy bandwidth usage by other disks in the topology will further reduce the overall performance of the duplication.

Currently, a storage topology generally consists at least of: (1) a host system, (2) one or more disks where the source data is contained, (3) any intermediary devices (e.g., one or more levels of SAS expanders) in the storage fabric, and (4) one or more destination disks. Currently, in a typical data duplication process the host must: initiate read I/Os from one or more source disks; transfer the data to some intermediate storage location (such as some memory); and then issue write I/Os to the destination disk. Throughout this process, the host must also handle any associated I/O errors or problems that occur throughout the topology. This current process of data duplication consumes a substantial associated bandwidth of a storage topology and results in a significant performance decrease of the host system that can endure for extended periods of time.

Therefore, it may be desirable to provide a method and apparatus which address the above-referenced problems associated with the data duplication process.

### SUMMARY OF THE INVENTION

Accordingly, a method is included for transfer of data from at least one source disk to at least one destination disk of a storage topology, the storage topology comprising a plurality of storage-topology-connected devices including at least one data-duplicating expander, the at least one source disk, and the at least one destination disk. This method may include receiving an instruction, instructions, trigger, or triggers from at least one initiator storage-topology-connected device to configure or start at least one data transfer. The method may also include transmitting instructions to the at least one source disk to reduce the accessibility of the at least one source disk and transmitting instructions to the at least one destination disk to reduce the accessibility of the at least one destination disk. This method may further include receiving source data from the at least one source disk by utilizing at least a first dedicated expander phy. Additionally, this method may include transferring destination data directly to the at least one destination disk by utilizing at least a second dedicated expander phy, said destination data associated with the source data, wherein directly transferring destination data bypasses transfer of the source data or the destination data to or from a host system.

Also included is a data-duplicating expander device attachable to a storage topology, the storage topology including at least one source disk and at least one destination disk. The device may include an expander configured to directly attach to the storage topology. The data-duplicating expander device may comprise a plurality of dedicated expander phys associated with the expander for attaching the expander to the storage topology. The data-duplicating expander device may include and be associated with at least one processor configured to process instructions or triggers. The device may be configured to receive an instruction, instructions, trigger, or triggers from at least one initiator storage-topology-connected device to configure or start at least one data transfer. The data-duplicating expander device may further be configured to transmit instructions to the at least one source disk and to the at least one destination disk. The device may also be configured to receive source data of the at least one source disk by utilizing at least a first dedicated expander phy. Additionally, the data-duplicating expander device may be configured to transfer destination data directly to the at least one destination disk by utilizing at least a second dedicated expander phy, said destination data associated with the source data, wherein directly transferring destination data bypasses transfer of the source data or the destination data to or from a host system.

Further included is a data-duplicating expander device. The device may include an SAS expander configured for direct duplication of data from a plurality of source disks to a plurality of destination disks. The device may be directly attached to a storage topology. The data-duplicating expander device may further comprise a plurality of dedicated expander phys and at least one processor configured to process instructions, commands, requests, or triggers. The device may be configured to receive an instruction, instructions, trigger, or triggers from at least one initiator storage-topology-connected device to configure or start at least one data transfer. The data-duplicating expander device may also be configured to transmit instructions to the plurality of source disks and the plurality of destination disks to reduce the accessibility of the plurality of source disks and the plurality of destination disks or to take the plurality of source disks and the plurality of destination disks offline. The data-duplicating expander device may further be configured to receive source data simultaneously from the plurality of source disks by utilizing at least two of the plurality of dedicated expander phys. The device may additionally be configured to transfer destination data directly and simultaneously to the plurality of destination disks by utilizing at least two of the plurality of dedicated expander phys, said destination data associated with the source data, wherein directly transferring destination data bypasses transfer of the source data or the destination data to or from a host system. The data-duplicating expander device may still further be configured to dynamically receive commands or requests from a host application and to extract status reports.

It is to be understood that both the foregoing general description and the following detailed description are exemplary and explanatory only and are not restrictive of the invention claimed. The accompanying drawings, which are incorporated in and constitute a part of the specification, illustrate embodiments of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of a typical storage topology associated with current disk duplication methods;

FIG. 2 shows a block diagram of a storage topology associated with embodiments of the present invention including a data-duplicating expander;

FIG. 3 shows a flow chart of a method associated with FIG. 2;

FIG. 4 shows a block diagram of a storage topology associated with embodiments of the present invention including a data-duplicating expander having data compression functionality;

FIG. 5 shows a flow chart of a method associated with FIG. 4;

FIG. 6 shows a block diagram of a storage topology associated with embodiments of the present invention including a data-duplicating expander and a dedicated disk duplication slot;

FIG. 7 shows a flow chart of a method associated with FIG. 6;

FIG. 8 shows a flow chart of a method associated with data transfer;

FIG. 9 shows an additional flow chart of a method associated with data transfer; and

FIG. 10 shows a further flow chart of a method associated with data transfer.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications, and equivalents are encompassed. For the purpose of clarity, technical material that is known in the technical fields related to the embodiments has not been described in detail to avoid unnecessarily obscuring the description.

The present invention may include a method and apparatus for improving data duplication and improving efficiency of data duplication of direct-attached devices of a storage topology. Embodiments of the present invention may include the use of one or more data-duplicating expanders. Data-duplicating expanders may include data-duplicating serial attached SCSI (SAS) expanders. Data-duplicating expanders, such as data-duplicating SAS expanders, may independently duplicate data or portions of data of one or more disks. Data-duplicating expanders may eliminate the need to route duplication data to the host or other system hardware components for a disk's data to be duplicated. Embodiments of the invention may further eliminate countless error conditions that can occur when transferring data from a source disk through the storage topology to the host and then back to a destination disk. Embodiments of the invention may significantly improve the host system performance during data duplication processes by eliminating unnecessary consumption of bandwidth typically used to transfer data from a source disk through the storage topology to a host and back to a destination disk. Thus, embodiments of this invention may optimize the data duplication process, may have significant impacts on systems, and may be a significant competitive advantage in industries dependent on data storage and data duplication.

A data-duplicating expander may be an SAS expander that performs a data duplication operation between two or more direct-attached devices. That is, the duplication operation typically handled by host control may be incorporated into the expander. The data duplication operation of a data-duplicating expander may be for an entire disk (i.e., a disk copy), a virtualized disk, a partitioned portion of a disk, or a selected region of a disk (e.g., LBA (“logical block address”) start to LBA end). A data-duplicating expander's data duplication operation may be controlled by a host application or host bus adapter (HBA). The data-duplicating expander's data duplication operation control by the HBA may include the HBA sending a configuration instruction or configuration instructions to the expander. For example, the HBA may send a configuration instruction or instructions to the expander (e.g., via vendor unique SMP (“Serial Management Protocol”) requests) for the purpose of using two dedicated SAS expander phys for transferring data from a source disk's LBA(s) to a destination disk's LBA(s) at the highest available link speed. These configuration instructions or instructions may result in a highly efficient data duplication using the shortest data path possible and may consume none of the bandwidth to the HBA. The host application may pre-configure or dynamically configure these dedicated SAS expander phys at any time to perform or to optimize performance of the data duplication task. For example a host application may dynamically configure a data-duplicating expander to pause, resume, cancel, abort, or skip duplication of an LBA range or ranges, resume duplication at a specified LBA, or redo duplication pursuant to instructions or status-report-event instructions that the data-duplicating expander may receive from the host application of the host system or HBA.

Computer-readable program instructions for carrying out duplicating the disk data may be built into the expander's hardware and/or firmware. The data-duplicating expander may include one or more processors for carrying out program instructions. The data-duplicating expander may include one or more computing devices, wherein a computing device may include one or more processors, storage, memory, other computer hardware, software, middleware, firmware, or the like.

Methods of duplication may include: (1) direct data duplication from any direct-attached source disk to any direct-attached destination disk, (2) the ability to apply a compression/decompression algorithm as the data is transferred from any direct-attached source disk to any direct-attached destination disk (this compression algorithm may be reversed for restoring data), or (3) the expander may be configured with a dedicated expander phy(s) that may initiate an automatic disk copy of a pre-selected source disk (for example, one or more disks may include dedicated duplication slot(s) in a JBOD (“just a bunch of disks”)).

Embodiments of the invention may include one or more data-duplicating expanders, such as SAS expanders configured for data duplication, which may manage multiple data duplications occurring simultaneously with minimal host intervention and minimal host CPU cycles. By way of example, a small, typical, or very large topology may have 50% of the disks, operatively configured as source disks, simultaneously being duplicated with almost no CPU usage to the other 50% of disks, operatively configured as destination disks. By additional way of example, a topology may have all but one of the disks, operatively configured as source disks, simultaneously being compressed and duplicated with almost no CPU or host resource usage to one other disk, operatively configured as a destination disk to store compressed data of the other disks. A disk may include any storage topology connectable storage device such as hard disk drives, solid state drives, or the like.

Furthermore, the data-duplicating expander may be configured to communicate with, network with, interact with, send instructions or status reports to, receive instructions from, receive triggers from, transfer data to or from, and operate with HBAs, expanders, source disks, destination disks, and dedicated duplication slots.

Embodiments may provide for disk duplication such that the associated performance penalties of currently-practiced methods of data duplication are no longer a burden to the host system or to the rest of the storage topology associated with paths from source device(s) to the host and then from the host to destination device(s). That is, the data duplication may be independently completed by the expander alone, without requiring HBA resources or redundant-path topology bandwidth for the data duplication operation.

Some embodiments may be configured to begin disk duplication as soon as a destination drive is attached to a specific phy in a JBOD (i.e., in a configuration where there is at least one dedicated slot for duplication purposes), where the JBOD is part of a data-duplicating expander, the JBOD includes a built-in or integrated data-duplicating expander, or the JBOD is operatively connected to a topology implemented with a data-duplicating expander, wherein said data duplicating expander may be a data-duplicating SAS expander. A user, an automated mechanical device, a robotic device, or switch may insert, attach, or connect one or more raw disks, such as disk drives or removable-writable disks, into one or more dedicated slots; and the data from one or more associated source disks may automatically be duplicated by the expander to the one or more raw destination disks.

In some implementations of embodiments of the invention, the data from one or more source disks may be modified by the data-duplicating expander, and then the data-duplicating expander transfers the modified source data to one or more destination disks.

In some implementations of embodiments of the invention, the modifying of source data by the data-duplicating expander may include compressing or decompressing source data through any of various compression/decompression algorithms and then transferring the compressed or decompressed source data to one or more destination disks. Compression/decompression algorithms may include standard, unique, or semi-unique algorithms implemented in firmware or hardware of the expander. By way of example, semi-unique algorithms may include unique-to-an-entity, unique-to-an-enterprise, unique-to-an-organization, unique-to-a-department, unique-to-an-industry, or unique-to-a-vendor algorithms. Different users, systems, processes, or applications could request or have access to request different compression and decompression algorithms to make the product unique or unique to certain groups of users. For example, a particular compression/decompression algorithm may be incompatible with a different vendor or different vendors' products. If no compression was necessary, very large sizes of I/Os (e.g., megabytes, 10s of megabytes, or larger) may be transferred with little-to-no data buffering required since all data received from the source disk would be immediately or almost immediately sent to the destination disk.

In other implementations of embodiments of the invention, the modifying of source data by the data-duplicating expander may include encrypting or decrypting source data through any of various encryption/decryption algorithms and then transferring the encrypted or decrypted source data to one or more destination disks. Encryption/decryption algorithms may include standard, unique, or semi-unique algorithms implemented in firmware or hardware of the expander. By way of example, semi-unique algorithms may include unique-to-an-entity, unique-to-an-enterprise, unique-to-an-organization, unique-to-a-department, unique-to-an-industry, or unique-to-a-vendor algorithms. Different users, systems, processes, or applications could request or have access to request different encryption/decryption algorithms to make the product unique or unique to certain groups of users for data security purposes.

The data-duplicating expander may be configured by the host to take the required disks offline, reduce the accessibility of required disks, or otherwise make the required disks inaccessible to other devices. Alternatively, the data-duplicating expander itself may take the required disks offline, reduce the accessibility of required disks, or otherwise make the required disks inaccessible to other devices. The data-duplicating expander may then perform the duplication task as quickly as possible with no need for the data to ever leave a direct path (e.g., the direct path from the source disk to the data-duplicating expander to the destination disk, or the direct path from the source disk to the destination disk if either or both of the source disk or destination disk include an integrated or built-in data-duplicating expander). Duplication over a direct path minimizes use of valuable topology bandwidth needed to send or transfer data to or from other devices and minimizes use of valuable host resources, such as CPU cycles. The data-duplicating expander, such as a data-duplicating SAS expander, may not be limited to a single duplication, but rather, may process multiple duplications simultaneously.

Special SMP (“Serial Management Protocol”) commands and requests may be used to configure the expander. SMP commands and requests may also be used for extracting status reports. The data-duplicating expander may be configured to handle complex error recovery scenarios by implementing one or more recovery algorithms. The one or more recovery algorithms may be implemented in firmware or hardware of the expander. Implementation of the recovery algorithm may allow the data-duplicating expander to take a particular recovery action in response to a particular status of a status report from a source or destination device. Recovery actions by the data-duplicating expander may include pausing, resuming (such as at a specified LBA), or aborting duplication, data transfer, compression, decompression, encryption, or decryption processes. Additionally, the data-duplicating expander may simply provide a status report to the host regarding the failure so the host may implement a recovery action. For example, once the host has completed the recovery, the data duplicating expander, such as a data duplicating SAS expander, may then be instructed as to where (such as at a specified LBA) to resume the duplication so as to avoid a restart of the entire duplication activity.

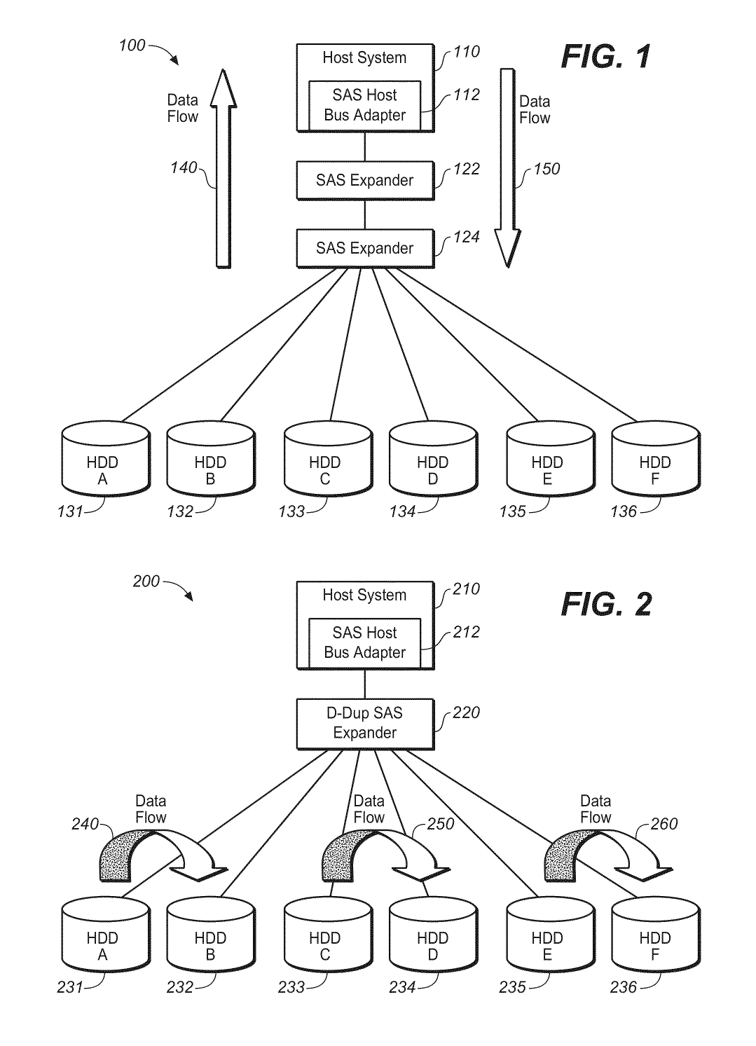

Referring to FIG. 1, a currently implemented storage topology 100 suitable for current data duplication methods is depicted. The currently implemented storage topology 100 may comprise: a host system 110, including an SAS host bus adapter 112; one or more SAS expanders 122, 124 on one or more levels; and a plurality of disks 131-136 (e.g., HDDs A-F). Even though HDD A 131 and HDD B 132 may physically be next to each other, mirroring the entire data contents of HDD A 131 to HDD B 132 includes reading all of HDD A's 131 data up (e.g., data flow 140) through the currently implemented storage topology 100 to the host 110 and then transferring all of the data back down (e.g., data flow 150) through the currently implemented storage topology 100 to be written to HDD B 132. This current method of data duplication impacts the entire system performance and also heightens the likelihood of read, write, and other errors along the data path (e.g., data flows 140, 150).

Referring to FIG. 2, a storage topology 200 suitable for data duplication methods (e.g., method 300, described below) and apparati of embodiments of the invention is depicted. The storage topology 200 may comprise: a host system 210, including an HBA, such as an SAS host bus adapter 212; one or more data duplicating expanders, such as a data-duplicating SAS expander 220, on one or more levels; and a plurality of disk drives (e.g., HDDs A-F 231-236). The host system 210 may be operatively interconnected to one or more expanders, including one or more data-duplicating expanders (e.g., 220), disks (e.g., 231-236), and other devices, such as other SAS devices, via suitable connecting means, such as SAS connectors. The data-duplicating expander (e.g., 220) may be operatively interconnected to other expanders, including other data-duplicating expanders, disks (e.g., 231-236), and other devices, such as other SAS devices, via suitable connecting means, such as SAS connectors. It is contemplated that embodiments of the disclosure may operate in accordance with the T10 SAS specification.

Referring still to FIG. 2, HDDs A, C, and E 231, 233, 235 may be copied or duplicated, in whole or part, to HDDs B, D, and F 232, 234, 236, respectively. To perform this duplication, data from HDDs A, C, and E 231, 233, 235 may be read by the data-duplicating SAS expander 220 and written directly to HDDs B, D, and F 232, 234, 236. Data flows 240, 250, 260 show the direct data flow from the source disks (e.g., HDDs A, C, and E 231, 233, 235) through the data duplicating expander (e.g., 220) to the destination disks (e.g., HDDs B, D, and F 232, 234, 236). Data flows 240, 250, 260 associated with the data duplication of HDDs A, C, and E 231, 233, 235 may be performed simultaneously, separately, or in some logical block or bit combination thereof. The duplication process no longer requires data flow (see, e.g., 140, 150 of FIG. 1) along a redundant path up to and back down from the host system 210.

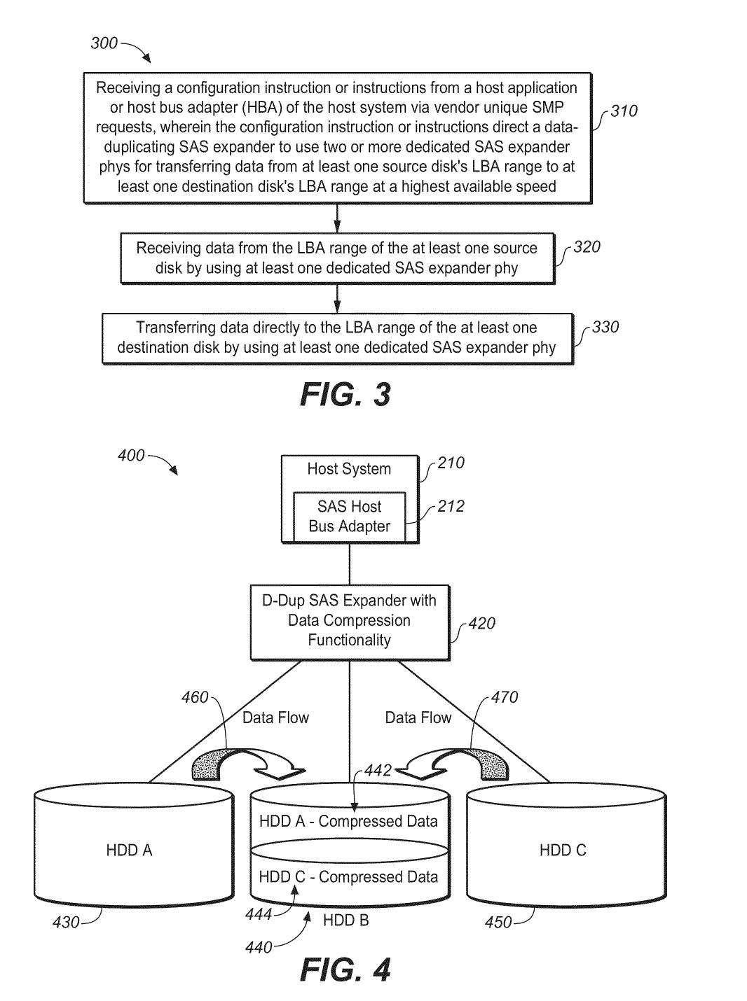

Referring to FIG. 3, an embodied data duplication method 300 associated with the storage topology 200 of FIG. 2 is depicted. It is contemplated that embodiments of the method 300 may be performed by a data-duplicating expander, such as a data-duplicating SAS expander (e.g., 220). The method 300 may include a step 310, wherein the step 310 may comprise receiving a configuration instruction or instructions from a host application or host bus adapter (HBA) of the host system via vendor unique SMP requests, wherein the configuration instruction or instructions direct a data-duplicating SAS expander to use two or more dedicated SAS expander phys for transferring data from at least one source disk's LBA range to at least one destination disk's LBA range at a highest available or negotiated speed. The method 300 may also include a step 320, wherein the step 320 may comprise receiving data from the LBA range of the at least one source disk using at least one dedicated SAS expander phy. The method 300 may include a step 330, wherein the step 330 may comprise transferring data directly to the LBA range of the at least one destination disk using at least one dedicated SAS expander phy.

Referring to FIG. 4, a storage topology 400, suitable for certain implementations of data duplication methods (e.g., method 500 (described below), as well as method 300) and apparati of embodiments of the invention, is depicted. The storage topology 400 may comprise: a host system 210, including an HBA, such as an SAS host bus adapter 212; one or more data duplicating expanders configured for at least one of data-compression or data-decompression, such as a data-duplicating compression/decompression-configured SAS expander 420, on one or more levels; and a plurality of disks (e.g., HDDs A, B, and C 430, 440, 450). The data-duplication compression/decompression-configured expander allows multiple disks, in whole or part, to be compressed or decompressed by the data-duplicating compression/decompression-configured expander. The data-duplicating compression/decompression-configured expander (e.g., 420) may use one or more compression/decompression algorithms loaded into the expander's (e.g., 420) firmware or hardware to perform compression or decompression of data from one or more source disks (e.g., 430, 450); additionally, the data-duplicating compression/decompression-configured expander (e.g., 420) may utilize an integrated hardware component to perform one or more compression/decompression algorithms to compress or decompress data from one or more source disks (e.g., 430, 450). The data-duplicating compression/decompression-configured expander (e.g., 420) may use one or more compression/decompression algorithms unique to implemented products of other vendors or unique to individual entities, enterprises, organizations, departments, or similar whole, part, divisional, or categorical groups of end-users for the purposes of preventing unintended uses of the compressed data and preventing use of the compressed data by non-contemplated or unintended users or processes.

Further referring to FIG. 4, the data-duplicating compression/decompression-configured expander (e.g., 420) may read or receive data from one or more source disks. Then, the data-duplicating compression/decompression-configured expander (e.g., 420) may compress or decompress the read or received data. As the data-duplicating compression/decompression-configured expander (e.g., 420) compresses data from one or more source disks (e.g., 430, 450), the data-duplicating compression/decompression-configured expander (e.g., 420) may immediately or near-immediately transfer the compressed or decompressed data (see, e.g., data flows 460, 470) directly to one or more destination disks (e.g., 440) for writing to the one or more destination disks (e.g., 440). Each of one or more destination disks (e.g., 440) may have the compressed data of multiple disks copied on to different LBA ranges of that particular destination disk (e.g., 440) as compressed data of a first disk (e.g., HDD A's compressed data 442 on HDD B 440) and compressed data of at least a second disk (e.g., HDD C's compressed data 444 on HDD B 440). Configuring the data-duplicating expander for compression/decompression may enhance both the performance and capacity of a system or a topology.

Additionally, the data compression and copying method by a data-duplicating compression-configured expander (e.g., 420) may be reversed to decompress and transfer the restored data to one or more source-disks-to-be-restored (e.g. 430, 450) to restore a previously backed up state from a single (or multiple) destination disk (e.g., 440), which contains the compressed data (e.g., 442, 444) or backup data of one or more source disks (e.g., 430, 450).

Additionally, referring to FIG. 4, the host system 210, one or more expanders, including one or more data-duplicating compression/decompression-configured expanders (e.g., the data-duplicating SAS expander configured for compression/decompression 420), plurality of disks (e.g., 430, 440, 450), and other devices, such as other SAS devices, may be operatively interconnected by suitable connecting means, such as with SAS connectors.

Referring still to FIG. 4, data flows 460, 470 associated with the compressing (or decompressing) of data of HDDs A and C 430, 450 and transferring to HDD B 440 may be performed simultaneously, separately, or in some logical block or bit combination thereof. The compression/decompression and data-transfer processes no longer require data flows (see, e.g., 140, 150 of FIG. 1) along a redundant path up to and back down from the host system 210.

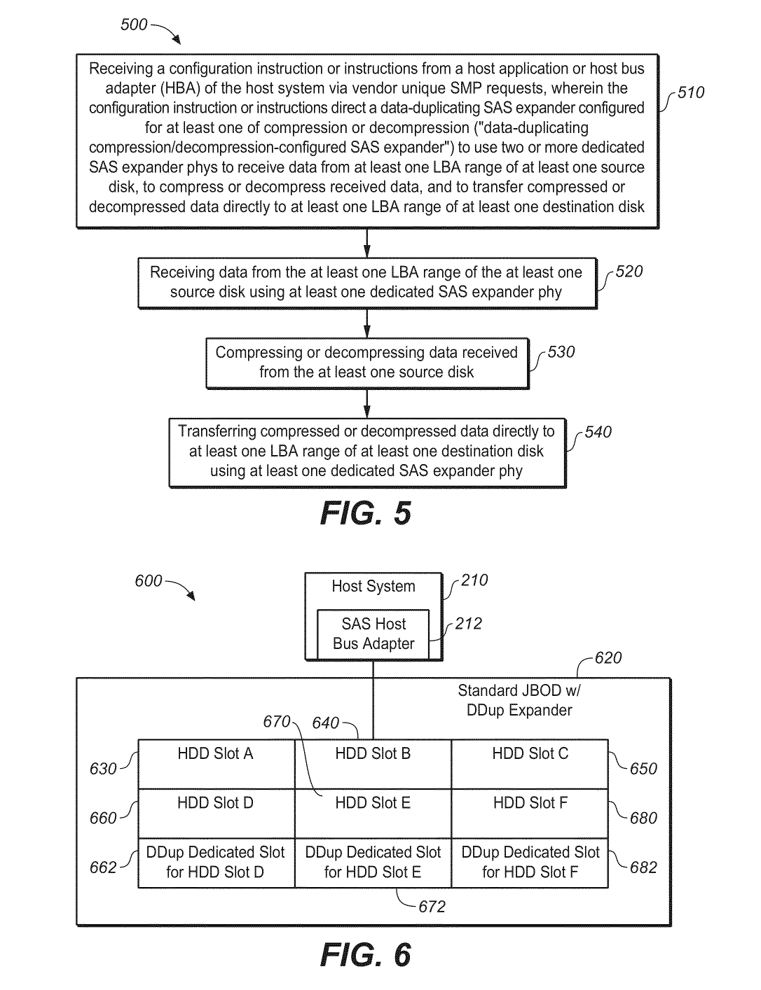

Referring to FIG. 5, an embodied data transfer method 500 associated with the storage topology 400 of FIG. 4 is depicted. It is contemplated that embodiments of the method 500 may be performed by a data-duplicating expander configured for one or both of compression or decompression, such as a data-duplicating compression/decompression-configured SAS expander (e.g., 420). The method 500 may include a step 510, wherein the step 510 may comprise receiving a configuration instruction or instructions from a host application or host bus adapter (HBA) of the host system via vendor unique SMP requests, wherein the configuration instruction or instructions direct a data-duplicating SAS expander configured for at least one of compression or decompression (“data-duplicating compression/decompression-configured SAS expander”) to use two or more dedicated SAS expander phys to receive data from at least one LBA range of at least one source disk, to compress or decompress received data, and to transfer compressed or decompressed data directly to at least one LBA range of at least one destination disk. The method 500 may include a step 520, wherein the step 520 may comprise receiving data from the at least one LBA range of the at least one source disk using at least one dedicated SAS expander phy. The method 500 may include a step 530, wherein the step 530 may comprise compressing or decompressing data received from the at least one source disk. The method 500 may include a step 540, wherein the step 540 may comprise transferring compressed or decompressed data directly to at least one LBA range of at least one destination disk using at least one dedicated SAS expander phy.

Referring to FIG. 6, a storage topology 600, suitable for certain implementations of data duplication methods (e.g., a method 700 (described below), as well as the method 300) and apparati of embodiments of the invention, is depicted. The storage topology 600 may comprise: a host system 210, including an HBA, such as an SAS host bus adapter 212; and one or more JBOD/data-duplicating expander devices 620, on one or more levels. A JBOD/data-duplicating expander device 620 may comprise a standard JBOD with one or more built-in or integrated data-duplicating expanders (such as a data-duplicating SAS expander) or with one or more built-in or integrated data-duplicating compression/decompression-configured expanders (such as a data-duplicating compression/decompression-configured SAS expander). The JBOD of the JBOD/data-duplicating expander device 620 may include a plurality of disks (e.g., HDD Slot A 630, HDD Slot B 640, HDD Slot C 650, HDD Slot D 660, HDD Slot E 670, and HDD Slot F 680). One or more of the plurality of disks (e.g., 660, 670, and 680) may be operatively associated with, connected to, or may include dedicated disk duplication slots (e.g., data-duplicating dedicated slot for HDD D 662, data-duplicating dedicated slot for HDD E 672, and data-duplicating dedicated slot for HDD F 682).

Each dedicated disk duplication slot (e.g., 662, 672, 682) may be configured for copying or duplicating the entire data contents or pre-selected or selected portion(s) of data contents of one or more associated disks (e.g., 660, 670, 680) to an inserted, engaged, or connected raw destination disk. A dedicated disk duplication slot (e.g., 662, 672, or 682) may further be configured to automatically begin copying or duplicating the entire data contents or pre-selected or selected portion(s) of data contents of an associated disk (e.g., 660, 670, or 680) automatically upon insertion, engagement, or connection of a raw disk to a dedicated disk duplication slot (e.g., 662, 672, or 682). A user or application can configure the expander or expanders of the JBOD/data-duplicating expander device 620 for as many dedicated disk duplication slots as desired or required, including none, one, or multiple dedicated disk duplication slots for each disk of the JBOD. Utilizing a JBOD/data-duplicating expander device may enhance system performance and efficiency when duplicating multiple disks.

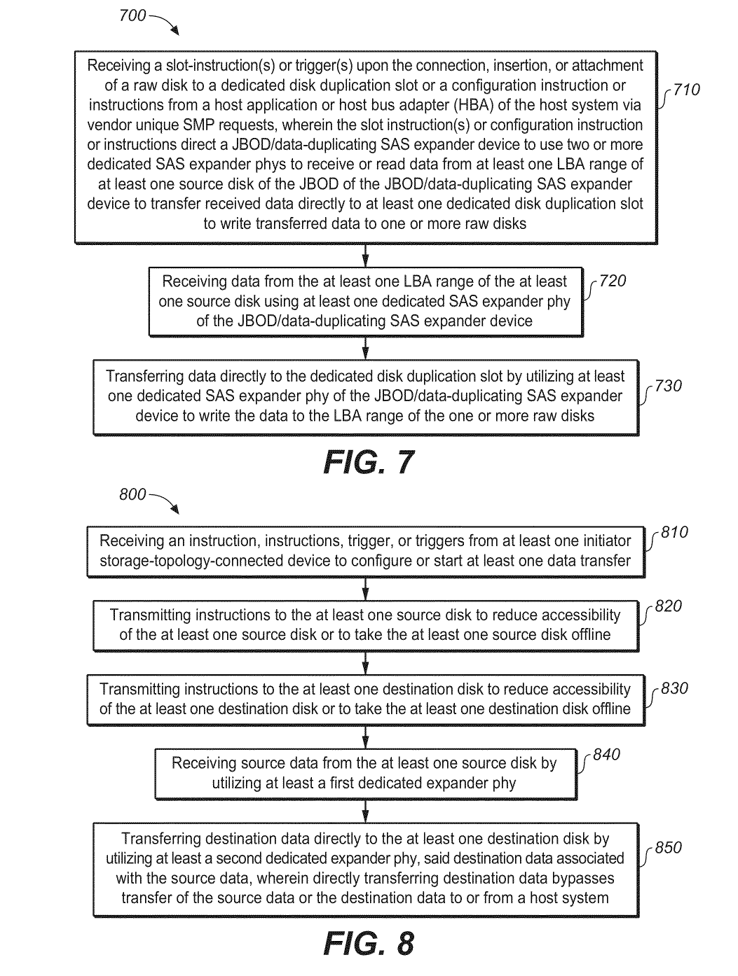

Referring to FIG. 7, an embodied data duplication method 700 associated with the storage topology 600 of FIG. 6 is depicted. It is contemplated that embodiments of the method 700 may be performed by a JBOD/data-duplicating expander device (such as JBOD/data-duplicating SAS expander device 620) or a built-in or integrated data-duplicating expander of the JBOD/data-duplicating expander device 620. The method 700 may include a step 710, wherein the step 710 may comprise receiving a slot-instruction(s) or trigger(s) upon the connection, insertion, or attachment of a raw disk to a dedicated disk duplication slot or a configuration instruction or instructions from a host application or host bus adapter (HBA) of the host system via vendor unique SMP requests, wherein the slot instruction(s) or configuration instruction or instructions direct a JBOD/data-duplicating SAS expander device to use two or more dedicated SAS expander phys to receive or read data from at least one LBA range of at least one source disk of the JBOD of the JBOD/data-duplicating SAS expander device to transfer received data directly to at least one dedicated disk duplication slot to write transferred data to one or more raw disks. The method 700 may also include a step 720, wherein the step 720 may comprise receiving data from the at least one LBA range of the at least one source disk using at least one dedicated SAS expander phy of the JBOD/data-duplicating SAS expander device. The method 700 may further include a step 730, wherein the step 730 may comprise transferring data directly to the dedicated disk duplication slot by utilizing at least one dedicated SAS expander phy of the JBOD/data-duplicating SAS expander device to write the data to the LBA range of the one or more raw disks.

Embodiments of the invention may include an initiator storage-topology-connected device. The initiator storage-topology-connected device may include a dedicated disk duplication slot or a host system or HBA. The initiator system-connected-device may trigger or instruct a data-duplicating expander to start a data transfer from at least one source disk to at least one destination disk. The initiator storage-topology-connected device may trigger the data-duplicating expander by using an application, such as a host application. Additionally, the initiator storage-topology-connected device may trigger the data-duplicating expander through implementations in hardware or firmware. Embodiments of the invention contemplate that an initiator storage-topology-connected device may include one or more host systems or one or more dedicated disk duplication slots.

It is also contemplated that an external initiator device may initiate or trigger the initiator storage-topology-connected device to in turn trigger the data-duplicating expander to start a transfer of data or duplication. The external initiator device may not need to be directly-attached to the storage topology. The external initiator device may communicate, interact with, and/or trigger the initiator storage-topology-connected device through wired or wireless networks. The external initiator device may allow for remote initiation of a data-duplicating expander to begin direct transfer of data from at least one source disk to at least one destination disk, wherein the external initiator device remotely triggers an initiator storage-topology-connected device to trigger a data-duplicating expander.

Referring to FIG. 8, an embodied method 800 associated with data transfer using a data-duplicating expander is depicted. It is contemplated that embodiments of the method 800 may be performed by an expander configured for data duplication (such as a data-duplicating SAS expander). The method 800 may include a step 810, wherein the step 810 may comprise receiving an instruction, instructions, trigger, or triggers from at least one initiator storage-topology-connected device to configure or start at least one data transfer. The method 800 may further include a step 820, wherein the step 820 may comprise transmitting instructions to the at least one source disk to reduce the accessibility of the at least one source disk or to take the at least one source disk offline. The method 800 may also include a step 830, wherein the step 830 may comprise transmitting instructions to the at least one destination disk to reduce the accessibility of the at least one destination disk or to take the at least one destination disk offline. The method 800 may also include a step 840, wherein the step 840 may comprise receiving source data from the at least one source disk by utilizing at least a first dedicated expander phy. The method 800 may also include a step 850, wherein the step 850 may comprise transferring destination data directly to the at least one destination disk by utilizing at least a second dedicated expander phy, said destination data associated with the source data, wherein directly transferring destination data bypasses transfer of the source data or the destination data to or from a host system.

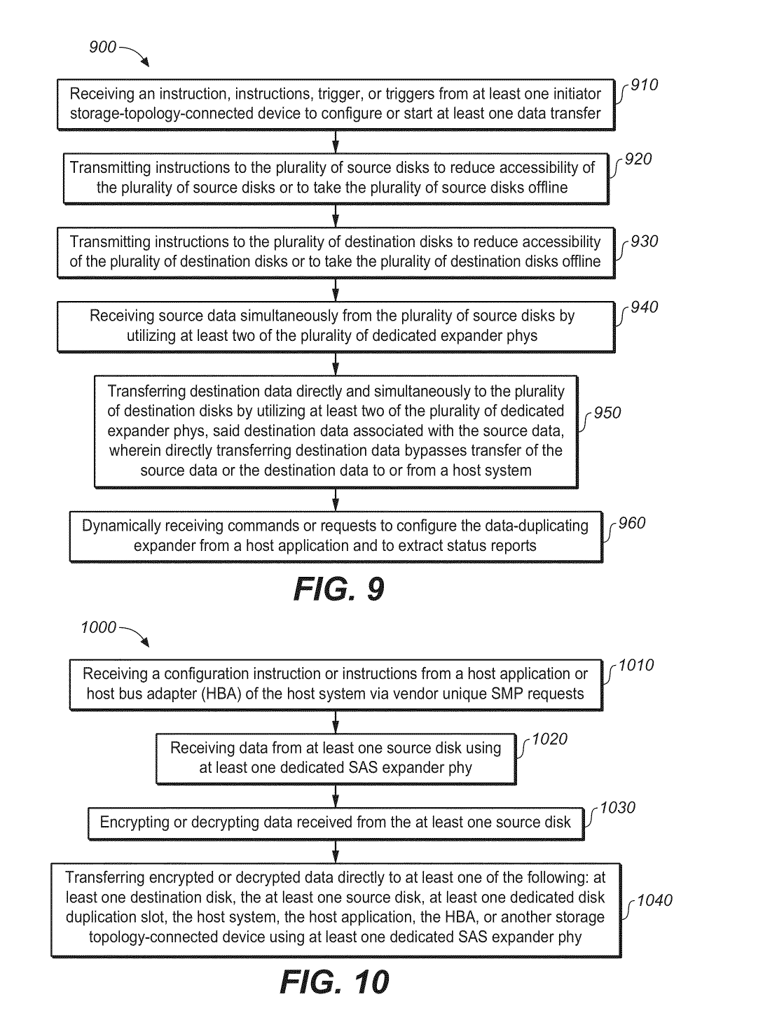

Referring to FIG. 9, an embodied method 900 associated with data transfer using a data-duplicating expander is depicted. It is contemplated that embodiments of the method 900 may be performed by a data-duplicating expander (such as a data-duplicating SAS expander). The method 900 may include a step 910, wherein the step 910 may comprise receiving an instruction, instructions, trigger, or triggers from at least one initiator storage-topology-connected device to configure or start at least one data transfer. The method 900 may include a step 920, wherein the step 920 may comprise transmitting instructions to the plurality of source disks to reduce the accessibility of the plurality of source disks or to take the plurality of source disks offline. The method 900 may further include a step 930, wherein the step 930 may comprise transmitting instructions to the plurality of destination disks to reduce the accessibility of the plurality of destination disks or to take the plurality of destination disks offline. The method 900 may further include a step 940, wherein the step 940 may comprise receiving source data simultaneously from the plurality of source disks by utilizing at least two of the plurality of dedicated expander phys. The method 900 may further include a step 950, wherein the step 950 may comprise transferring destination data directly and simultaneously to the plurality of destination disks by utilizing at least two of the plurality of dedicated expander phys, said destination data associated with the source data, wherein directly transferring destination data bypasses transfer of the source data or the destination data to or from a host system. The method 900 may further include a step 960, wherein the step 960 may comprise dynamically receiving commands or requests to configure the data-duplicating expander from a host application and to extract status reports.

Referring to FIG. 10, an embodied data transfer method 1000 is depicted. It is contemplated that embodiments of the method 1000 may be performed by a data-duplicating expander configured for one or both of encryption or decryption, such as a data-duplicating encryption/decryption-configured SAS expander. The method 1000 may include a step 1010, wherein the step 1010 may comprise receiving a configuration instruction or instructions from a host application or host bus adapter (HBA) of the host system via vendor unique SMP requests. The method 1000 may also include a step 1020, wherein the step 1020 may comprise receiving data from at least one source disk using at least one dedicated SAS expander phy. The method 1000 may further include a step 1030, wherein the step 1030 may comprise encrypting or decrypting data received from the at least one source disk. Additionally, the method 1000 may include a step 1040, wherein the step 1040 may comprise transferring encrypted or decrypted data directly to at least one of the following: at least one destination disk, the at least one source disk, at least one dedicated disk duplication slot, the host system, the host application, the HBA, or another storage topology-connected device using at least one dedicated SAS expander phy.

Additionally, features, functionality, and storage-topology-connected devices of the topology 100, associated with FIG. 1; the topology 200 and the method 300, associated with FIGS. 2 and 3; the topology 400 and the method 500, associated with FIGS. 4 and 5; the topology 600 and the method 700, associated with FIGS. 6 and 7; the method 800, associated with FIG. 8; the method 900, associated with FIG. 9; and the method 1000, associated with FIG. 10, may be included together, modified by each other, or combined to create more complex and larger topologies with one or multiple expanders and/or one or multiple expander devices, including any combination of expanders (such as SAS expanders), data-duplicating expanders (such as data-duplicating SAS expanders), data-duplicating compression/decompression-configured expanders (such as data-duplicating compression/decompression-configured SAS expanders), data-duplicating encryption/decryption-configured expanders (such as data-duplicating encryption/decryption-configured SAS expanders), data-duplicating compression/decompression-encryption/decryption-configured expanders (such as data-duplicating compression/decompression-encryption/decryption-configured SAS expanders), JBOD/data-duplicating expander devices (such as JBOD/data-duplicating SAS expander devices), JBOD/data-duplicating compression/decompression-configured expander devices (such as JBOD/data-duplicating compression/decompression-configured SAS expander devices) and JBOD/data-duplicating encryption/decryption-configured expander devices (such as JBOD/data-duplicating encryption/decryption-configured SAS expander devices), wherein the expanders or expander devices may be on one or more levels; one or multiple disks and/or one or multiple JBODs; one or more initiator storage-topology-connected devices; one or more external initiator devices; one or more dedicated disk duplication slots; and one or multiple hosts. For example, the topology 400 of FIG. 4 may modified by or combined with FIG. 6 to additionally include a dedicated disk duplication slot (similar to 662, 672, or 682 of FIG. 6) operatively associated with HDD B 440 such that a raw disk may be inserted in, attached to, or connected to the dedicated disk duplication slot associated with HDD B 440 to copy the entire disk contents of HDD B 440 to the raw disk, thereby copying the compressed disk copy 442 of HDD A 430 and the compressed disk copy 444 of HDD C 450 to the raw disk.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for transfer of data from at least one source disk to at least one destination disk of a storage topology, the storage topology including a plurality of storage-topology-connected devices including at least one data-duplicating expander, the at least one source disk, and the at least one destination disk, the method comprising:
receiving an instruction, instructions, trigger, or triggers from at least one initiator storage-topology-connected device to configure or start at least one data transfer;
transmitting instructions to the at least one source disk to reduce accessibility of the at least one source disk or to take the at least one source disk offline;
transmitting instructions to the at least one destination disk to reduce accessibility of the at least one destination disk or to take the at least one destination disk offline;
receiving source data from the at least one source disk by utilizing at least a first dedicated expander phy; and
transferring destination data directly to the at least one destination disk by utilizing at least a second dedicated expander phy, said destination data associated with the source data, wherein directly transferring destination data bypasses transfer of the source data or the destination data to or from a host system.

2. The method of claim 1, wherein said data-duplicating expander comprises a data-duplicating SAS expander.

3. The method of claim 1, wherein the at least one initiator storage-topology-connected device comprises the host system or host bus adapter.

4. The method of claim 1, wherein the step of receiving source data includes: receiving source data simultaneously from a plurality of source disks; and wherein the step of transferring destination data includes: transferring destination data simultaneously to a plurality of destination disks.

5. The method of claim 1, wherein the destination data comprises unmodified source data.

6. The method of claim 1, wherein the data-duplicating expander is further configured for modifying the source data and transferring modified source data as the destination data, the method further comprising: modifying the source data.

7. The method of claim 1, further comprising at least one of: compressing, decompressing, encrypting, or decrypting the source data.

8. The method of claim 1, wherein the at least one initiator storage-topology-connected device comprises at least one dedicated disk duplication slot, each of said at least one dedicated disk duplication slot operatively connected to at least one disk of the storage topology.

9. The method of claim 1, wherein the data-duplicating expander comprises a JBOD/data-duplicating expander device, said JBOD/data-duplicating expander device including at least one built-in, attached, or integrated data-duplicating expander and a built-in, attached, or integrated JBOD.

10. A data-duplicating expander device attachable to a storage topology, the storage topology comprising at least one source disk and at least one destination disk, said data-duplicating expander device comprising:
an expander, the expander configured to directly attach to the storage topology;
a plurality of dedicated expander phys for attaching the expander to the storage topology, the plurality of dedicated expander phys associated with the expander; and
at least one processor configured at least to process instructions or triggers, the at least one processor associated with the expander;
wherein the data-duplicating expander device is configured to:
receive an instruction, instructions, trigger, or triggers from at least one initiator storage-topology-connected device to configure or start at least one data transfer;
transmit instructions to the at least one source disk;
transmit instructions to the at least one destination disk;
receive source data from the at least one source disk by utilizing at least a first dedicated expander phy; and
transfer destination data directly to the at least one destination disk by utilizing at least a second dedicated expander phy, said destination data associated with the source data, wherein directly transferring destination data bypasses transfer of the source data or the destination data to or from a host system.

11. The device of claim 10, wherein said data-duplicating expander comprises a data-duplicating SAS expander.

12. The device of claim 10, wherein the at least one initiator storage-topology-connected device comprises the host system or host bus adapter.

13. The device of claim 10, wherein being configured to receive source data further includes being configured to: receive source data simultaneously from a plurality of source disks; and wherein being configured to transfer destination data further includes being configured to: transfer destination data simultaneously to a plurality of destination disks.

14. The device of claim 10, wherein the destination data comprises unmodified source data.

15. The device of claim 10, wherein the data-duplicating expander is further configured for modifying the source data and transferring modified source data as the destination data, the data-duplicating expander being further configured to: modify the source data.

16. The device of claim 10, wherein the data-duplicating expander further comprises a data-duplicating compression/decompression-configured expander configured for compressing or decompressing the source data and transferring compressed or decompressed source data as the destination data, the data-duplicating compression/decompression-configured expander being further configured to: compress or decompress the source data.

17. The device of claim 10, wherein the data-duplicating expander further comprises a data-duplicating encryption/decryption-configured expander configured for encrypting or decrypting the source data and transferring encrypted or decrypted source data as the destination data, the data-duplicating encryption/decryption-configured expander being further configured to: encrypt or decrypt the source data.

18. The device of claim 10, wherein the at least one initiator storage-topology-connected device comprises at least one dedicated disk duplication slot, each of said at least one dedicated disk duplication slot operatively connected to at least one disk of the storage topology.

19. The device of claim 10, wherein the data-duplicating expander comprises a JBOD/data-duplicating expander device, said JBOD/data-duplicating expander device including at least one built-in, attached, or integrated data-duplicating expander and a built-in, attached, or integrated JBOD.

20. A data-duplicating expander device, comprising:
an SAS expander, the SAS expander for direct duplication of data from a plurality of source disks to a plurality of destination disks, said SAS expander configured to directly attach to a storage topology;
a plurality of dedicated expander phys for attaching the expander to the storage topology, the plurality of dedicated expander phys associated with the SAS expander; and
at least one processor configured at least to process instructions, commands, requests, or triggers, the at least one processor associated with the SAS expander;
wherein the data-duplicating expander device is configured to:
receive an instruction, instructions, trigger, or triggers from at least one initiator storage-topology-connected device to configure or start at least one data transfer;
transmit instructions to the plurality of source disks to reduce accessibility of the plurality of source disks or to take the plurality of source disks offline;
transmit instructions to the plurality of destination disks to reduce accessibility of the plurality of destination disks or to take the plurality of destination disks offline;
receive source data simultaneously from the plurality of source disks by utilizing at least two of the plurality of dedicated expander phys;
transfer destination data directly and simultaneously to the plurality of destination disks by utilizing at least two of the plurality of dedicated expander phys, said destination data associated with the source data, wherein directly transferring destination data bypasses transfer of the source data or the destination data to or from a host system; and
dynamically receive commands or requests to configure the data-duplicating expander from a host application and to extract status reports.
